(19) United States
(12) Patent Application Publication
(10) Pub. No.: US 2021/0357740 A1
(43) Pub. Date: Nov. 18, 2021

(54) SECOND-ORDER OPTIMIZATION METHODS FOR AVOIDING SADDLE POINTS DURING THE TRAINING OF DEEP NEURAL NETWORKS

(71) Applicant: Siemens Aktiengesellschaft, Munich (DE)

(72) Inventors: Xi He, Allentown, PA (US); Ioannis Akrotirianakis, Princeton, NJ (US); Amit Chakraborty, East Windsor, NJ (US)

(21) Appl. No.: 16/337,154

(22) PCT Filed: Apr. 12, 2018
(86) PCT No.: PCT/US2018/027215

§ 371 Date: Mar. 27, 2019

(51) Int. Cl. G06N 3/08; G06K 9/62

(52) U.S. Cl. CPC G06N 3/08; G06K 9/6298; G06K 9/6228

(57) ABSTRACT

A computer-implemented method for training a deep neural network includes defining a loss function corresponding to the deep neural network, receiving a training dataset comprising training samples, and setting current parameter values to initial parameter values. An optimization method is performed which iteratively minimizes the loss function. During each iteration, a steepest direction of the loss function is calculated by determining the gradient of the loss function at the current parameter values. A batch of samples included in training samples is selected. A matrix-free CG solver is applied to obtain an inexact solution to a linear system defined by the steepest direction of the loss function and a stochastic Hessian matrix with respect to the batch of samples. A descent direction is determined, and the parameter values are updated based on the descent direction. Following the optimization method, the parameter values are stored in relationship to the deep neural network.

### TECHNICAL FIELD

The present disclosure relates to second-order optimization methods for avoiding saddle points during the training of neural networks. The technology described herein is particularly well-suited for, but not limited to, optimization problems encountered in deep learning applications.

### BACKGROUND

Deep neural networks have been used for achieving state-of-the-art results on a wide variety of tasks such as image-classification and objects recognition, Natural Language Processing, and speech recognition. In the past few decades, many different neural network architectures have been considered to apply on real-world applications Convolutional Neural Networks (CNNs) for processing data with a known grid-like structure, or Recurrent Neural Networks (RNNs) for addressing tasks involving time dimension in data. The development of pre-training, better forms of initialization, fruitful variants of training techniques and improved hardware have made it possible to train very deep network and achieve excellent performance.

A complex and highly non-convex optimization problem is at the core of training deep neural networks. For a multi-label classification problem, given n sample-label pairs (xᵢ, yᵢ)ᵢⁿ=₁, we construct neural network models h with respect to parameter θ to obtain the predicted labels [symbol] =h(xᵢ, θ) for each input sample xᵢ. If we denote the loss function for the i-th sample by f(yᵢ, yᵢ), the overall training loss for the entire sample set is then defined by

$$F ( X , Y ; θ ) - \frac{1}{n} {\sum }_{i = 1}^{n} f ( {\hat{y}}_{i} , {y}_{i} ) , \qquad ( 1 )$$

where the loss function fi(θ)=f( [symbol] , yᵢ) may include the squared error ∥yᵢ−yₓ∥²/2 and the cross-entropy error −Σⱼ(yᵢⱼ log(ŷᵢⱼ)+(1−yᵢⱼ)log(1−ŷᵢⱼ)). Note that all of the loss functions are nonnegative. The ultimate goal is then to minimize the overall training loss (1) to obtain the best parameter θ* such that the least classification error on both the validation and testing datasets is achieved.

Currently, the most popular methodologies to train networks are in the category of first-order (or gradient-based) optimization framework, like mini-batch stochastic gradient method (MSGD), mini-batch stochastic gradient method with momentum (ASGD), and other variants such as Adagrad, Adadelta, and Adam. There are also plenty of practical improving techniques to enhance the training performance, such as drop-out, batch normalization, layer normalization, to name but a few.

In training neural networks, especially when addressing deep neural networks with a large amount of data samples, one of the main challenges is the relatively slow training rate. Besides, computational results claim that it is more likely to achieve better training/testing performance when the optimization algorithms could help converge to a local minimizer of training loss function defined in Equation (1). However, since the models defined by deep neural networks are always highly non-convex, the number of saddle points increases exponentially as the number of hidden layers and corresponding neurons increases. Within the neighborhood of saddle points, the first-order methods may hardly make progress due to the nearly zero gradient of the loss function. Therefore, the first-order methods suffer to escape from saddle points and show frustratingly slow convergence rate after initial progress. Recent work suggests adding noise to the stochastic gradients to prevent slowdown near a saddle point.

The second-order methods, as an alternative to training deep neural network, were widely discussed in recently years. Examples include Hessian-free optimization in, L-B FGS optimization in and saddle-free Newton (SFN) method in. The extensions of the original work include the improvement of the preconditioning matrix for conjugate gradient (CG) solver, as well as the parallel/distributed variants for second-order methods. Among the previous works, either fully connected feed forward neural networks (DNNs) or recurrent neural networks (RNNs) were considered.

### SUMMARY

Embodiments of the present invention address and overcome one or more of the above shortcomings and drawbacks, by providing methods, systems, and apparatuses related to second-order optimization methods for avoiding saddle points during the training of deep neural networks.

According to some embodiments, a computer-implemented method for training a deep neural network includes defining a loss function corresponding to the deep neural network, receiving a training dataset comprising training samples, and setting current parameter values to initial parameter values. An optimization method is performed which iteratively minimizes the loss function. During each iteration, a steepest direction of the loss function is calculated by determining the gradient of the loss function at the current parameter values. A batch of samples included in training samples is selected. A matrix-free CG solver is applied to obtain an inexact solution to a linear system defined by the steepest direction of the loss function and a stochastic Hessian matrix with respect to the batch of samples. A descent direction is determined based on the inexact solution to the linear system and the steepest direction of the loss function, and the current parameter values are updated based on the descent direction. Following the optimization method, the current parameter values are stored in relationship to the deep neural network.

Various enhancements, refinements, or other modifications may be made to the aforementioned in different embodiments. For example, in one embodiment, the current parameter values are updated based on the descent direction and a learning rate calculated using the steepest direction of the loss function and the descent direction. The learning rate may be calculated, for example, using an Amijo line search method or a Goldstein line-search method. In one embodiment, the batch of samples comprises a random sampling of the plurality of training samples. This random sampling may be calculated a single time, or the training samples may be resampled during each iteration. In another embodiment, the optimization method is performed using a parallel computing platform and computing operations associated with the optimization method are performed in parallel across a plurality of processors included in the parallel computing platform.

According to other embodiments of the present invention, a computer-implemented method for training a deep neural network includes defining a loss function corresponding to the deep neural network, receiving a training dataset comprising a plurality of training samples, and setting current parameter values to initial parameter values. A computing platform is used to perform an optimization method which iteratively minimizes the loss function over a plurality of iterations. During each iteration of the optimization method, a gradient for the loss function is calculated at the current parameter values, and a batch of samples included in the plurality of training samples is selected. A trust region subproblem is constructed that approximates the loss function using the gradient and a stochastic Hessian matrix of the loss function with respect to the batch of samples. A descent direction is determined by applying a SteihaugCG solver to the trust region subproblem given a trust region radius. The current parameter values and the trust region radius are conditionally updated based on a comparison of (i) a true reduction value provided by the loss function given the current parameter values, and (ii) a predicted reduction value provided by the descent direction. Following the optimization method, the current parameter values are stored in relationship to the deep neural network.

In some embodiments of the aforementioned second method for training a deep neural network, the trust region radius corresponds as a spherical area in which the trust region subproblem lies. In other embodiments, the trust region subproblem is a bounded quadratic minimization problem.

In one embodiment of the aforementioned second method for training a deep neural network, the current parameter values are updated by selecting a learning rate for the descent direction and determining a first set of parameters based on the product of the descent direction and the learning rate. A momentum descent direction at the first set of parameters is also determined. A momentum rate is selected for the momentum descent direction, and the current parameter values are updated based on the first set of parameters and the product of the momentum descent direction and the momentum rate. In one embodiment, the learning rate is determined using a backtracking line search based on the loss function, the current parameter values, and the descent direction. In another embodiment, the momentum rate is determined using a backtracking line search based on the loss function, the first set of parameters, and the momentum descent direction.

Additional features and advantages of the invention will be made apparent from the following detailed description of illustrative embodiments that proceeds with reference to the accompanying drawings.

### BRIEF DESCRIPTION OF THE DRAWINGS

The foregoing and other aspects of the present invention are best understood from the following detailed description when read in connection with the accompanying drawings. For the purpose of illustrating the invention, there are shown in the drawings embodiments that are presently preferred, it being understood, however, that the invention is not limited to the specific instrumentalities disclosed. Included in the drawings are the following Figures:

FIG. 1 illustrates the Stochastic Newton-CG (SINNC) method for training a deep neural network, according to some embodiments;

FIG. 2 shows pseudocode for an example implementation of an Inexact Stochastic Newton-CG (SINNC) algorithm;

FIG. 3 shows an example algorithm for SteihaugCG solver;

FIG. 4 illustrates a computer-implemented method for training a deep neural network using the Inexact Stochastic Trust Region method, as it may be implemented in some embodiments;

FIG. 5 shows pseudocode for an example implementation of the Inexact Stochastic Trust Region method (SINTR) algorithm;

FIG. 6 shows pseudocode for an example implementation of the SINTR+ algorithm;

FIG. 7 provides an overview of how momentum, determined using SINTR+, may be used to update parameters following execution of the rest of the SINTR method;

FIG. 8 shows the evolution of angles between two adjacent iterative points and the corresponding optimization performance of SINTR and SINTR+; and

FIG. 9 provides an example of a parallel processing memory architecture that may be utilized by to perform computations related to execution of the algorithms discussed herein.

### DETAILED DESCRIPTION

Systems, methods, and apparatuses are described herein which relate generally to second-order optimization methods for avoiding saddle points during the training of deep neural networks. More specifically, the techniques described herein employ two stochastic Hessian-based methods: Inexact Stochastic Newton-CG (SINNC) and Inexact Stochastic Trust Region method (SINTR). These two methods use stochastic Hessian information for detecting the negative curvature direction efficiently. An earlier-terminated CG solver is given to find an approximate solution for the possibly indefinite sub-problem for SINNC and the SteihaugCG solver is applied and learned in SINTR. A number of illustrated examples are used to demonstrate the superior performance of SINNC and SINTR compared to MSGD and its variants in terms of loss objective value reduction and training accuracy. By using the proposed second-order methods, one could converge to a flatter minimizer which also provides better generalizations of the training model. Thus, SINNC and SINTR show promise in solving large DNNs and achieving better accuracy than MSGD type methods.

In the descriptions provided below, the following terminology is used. Denote [n]:={1, . . . , n}. We use fᵢ to denote the loss function corresponding to the i-th sample and label pair (xᵢ, yᵢ), where i∈[n]. X and Y represent the samples matrix (xᵢ . . . , xₙ) and labels vector (yᵢ, . . . yₙ). We use

$${H}_{S} = \frac{1}{\vert S \vert} {\sum }_{i ∈ S} {∇}^{2} {f}_{i}$$

to denote the stochastic Hessian matrix with respect to batch θ≠S⊂[n].

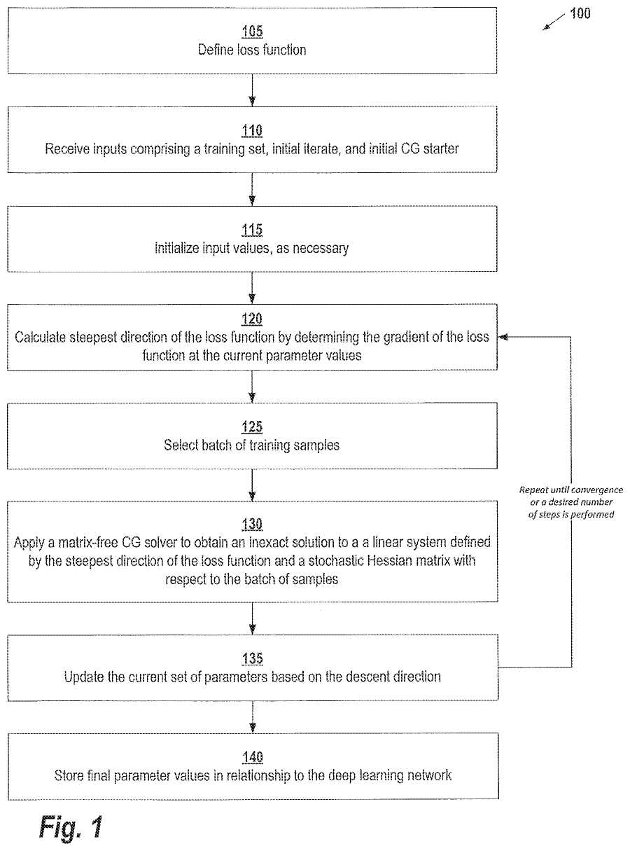

FIG. 1 illustrates the SINNC method 100 for training a deep neural network, according to some embodiments. This method 100 may be performed, for example, using a parallel computing platform and computing operations associated with the optimization method performed in parallel across a plurality of processors included in the parallel computing platform. Briefly, at each iteration, the full gradient is computed and used for finding an inexact stationary point corresponding to a stochastic Hessian. As is generally known in the art, the Hessian at the stationary point indicates whether we are at a local minimum, local maximum or a saddle point. More precisely, the stationary point variable is a point on the graph of the function where the function's derivative is zero and the function no longer increases or decreases.

Starting at step 105, a loss function corresponding to the deep neural network is defined. As is generally understood in the art, a loss function is used to guide the training process of a deep neural network. Various loss functions known in the art (e.g., Cross-Entropy, Mean Squared Error, etc.) may be used with the techniques described herein, as well as custom loss functions designed for particular datasets or applications. In general, the loss function of the deep neural network will be known in advance based on the characteristics of the deep neural network. Thus, defining the loss function at step 105 may be simply a matter of specifying the details of the loss function.

At step 110, various inputs are received, for example, as parameters supplied by a user. These inputs comprise a training set comprising labeled pairs(xᵢ,yᵢ)ᵢ₌₁ⁿ, an initial iterate Θ₀, and an initial CG starter d₀. Additionally, configuration information is supplied indicating a CG iteration limit kₘₐₓ, constant c∈(0,1), and a sample size β∈[n]. Finally, at step 115, the inputs are set to initial values, as necessary.

Steps 120-135 illustrate an optimization method which iteratively minimizes the loss function over a plurality of iterations. At step 120, the steepest direction of the loss function is calculated by determining the gradient of the loss function at the current parameter values. More generally, the full gradient is evaluated gₜ=∇F(Θ_{T}). Next, a batch of training samples S_{T}∈[n] is selected at step 125. This batch of samples may be created, for example, using a random sampling of the plurality of training samples such that that |S_{y}|=β. Such a random sampling may be performed, for example, a single time during the first iteration of the optimization method. Alternatively, the batch can be resampled during each iteration.

A matrix-free CG solver is applied at step 130 to obtain an inexact solution dₜ to a linear system defined by the steepest direction of the loss function and a stochastic Hessian matrix with respect to the batch of samples (i.e., the possible indefinite linear system H_{S}_{ₜ}d=−gₜ). The direction may be forced to be descent by flipping its sign if necessary. More specifically, the descent direction is decided as pₜ=−sgn(gₜ^{T}dₜ)dₜ, where sgn(x)=1 if x≥0, and sgn(x)=−1 if x<0. As is generally understood in the art of optimization algorithms, the term “descent direction” refers to a vector that moves one close to a local minimum of an objective function (in this case, the defined loss function).

The current parameter values are updated at step 135 based on the descent direction. In some embodiments, to ensure sufficient reduction of the loss function at each iteration, the current parameter values may also be updated using the learning rate calculated using the steepest direction of the loss function and the descent direction. This learning rate may be calculated, for example, using an Amijo line search method or a Goldstein line-search method. Examples of generic implementations of these methods are described in Nocedal J., and Wright S. J., “Numerical Optimization,” Springer Series in Operations Research and Financial Engineering, 2^{nd} Edition, 2006. Thus, the learning rate ηₜ may be selected as the largest element in the set {1, c, c², . . . } such that F(Θ_{T}+ηₜpₜ)≤F(Θ_{T})+cηₜgₜ^{T}pₜ. The updating of the parameters at step 135 is then a matter of updating Θ_{T+1} to Θ_{T}+ηₜpₜ. The optimization method then repeats again starting at step 120 until convergence or a desired number of steps are performed.

Following the optimization method, at step 140, the current parameter values are stored in relationship to the deep neural network. More specifically, the final parameter values are stored in a computer readable medium such that they can be used during deployment of the deep neural network on real-world data.

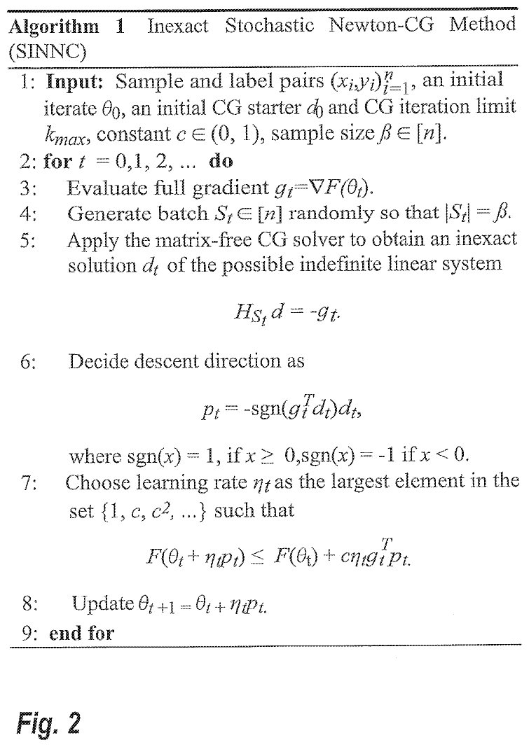

Note that, unlike truncated Newton-CG methods used in conventional systems, the method 100 considers negative curvature information indicated from the stochastic Hessian matrix. The method 100 also unitizes the stochastic Hessian-vector product but there is no need to evaluate the full Hessian, which is required by saddle-free Newton (SFN) methods. Pseudocode for an example implementation of the SINNC algorithm is set forth in FIG. 2.

To train neural network by second-order methods, the stochastic Hessian matrix and stochastic general Gaussian-Newton matrix are adopted as the approximation of the Hessian matrix, and further build the stochastic quadratic approximated model depending on them. Because training a deep neural network always involves a very large number of parameters, the exact solution of minimizing the quadratic approximation is prohibitive. Instead, we try to achieve a reasonable inexact solution in a computationally cost effective manner. Because the conjugate gradient method (CG) is often used to achieve an increasingly accurate solution after several iterations, the techniques described herein apply CG to minimize our quadratic model.

A known deficiency of the CG method is that it becomes unstable when an indefinite Hessian matrix is encountered during the minimization of the quadratic model. The reason behind this is that with an indefinite Hessian matrix, we may not find a conjugate direction. Several strategies have been proposed to deal with that deficiency, such as to modify the indefinite Hessian matrix so that the matrix can be positive and apply the CG solver afterward, or to apply a trust region approach which can always find a descent direction, or to use truncated Newton method, which terminates CG iteration whenever the negative curvature is encountered. In embodiments of the present invention, an early-terminated CG solver is applied in order to find an inexact solution for the quadratic model. With a good initial point, one could build a sequence of conjugate directions. From which, we could guarantee to reduce the residue of the system until the terminated condition is satisfied.

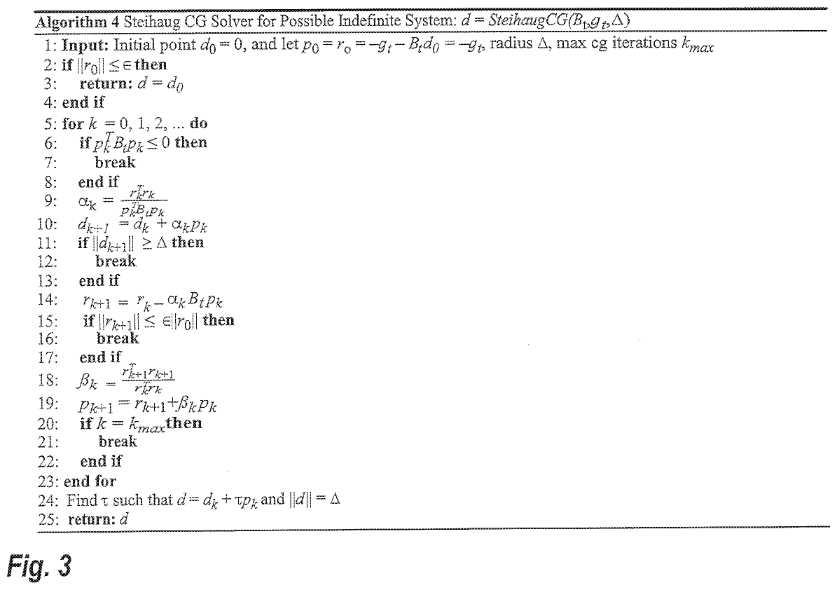

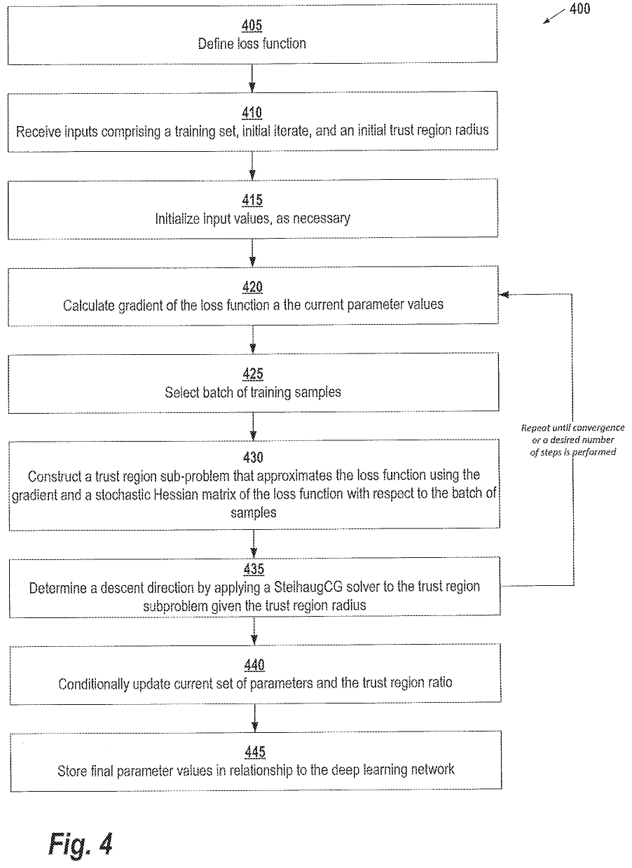

FIG. 4 illustrates a computer-implemented method 400 for training a deep neural network using the SINTR method, as it may be implemented in some embodiments. SINTR uses a stochastic Hessian-vector product and SteihaugCG solver to help escape saddle points. Trust region methods are commonly used to enforce global convergence to such non-convex optimization problems. They rely on solving a bounded quadratic minimization problem mₜ(d) at each iterate θₜ, which is constructed by using the approximated Hessian information. The bound Ω of the quadratic model is chosen so that mₜ(d) remains a reasonable approximation of F for any d∈Ω. Usually, it is a hard problem to find the exact solution of the quadratic model, therefore, the method 400 relies on a SteihaugCG solver CG to obtain a reasonable inexact solution. As is generally understood in the art, a SteihaugCG solver is a powerful CG variant to resolve the indefinite subproblem issue. As described below, a SteihaugCG solver with stochastic Hessian approximation (which is probably indefinite) provides at least the same reduction as Cauchy point. For reference, an example algorithm for a SteihaugCG solver is set forth in FIG. 3. Examples of generic implementations of CG and the SteihaugCG solver that can be adapted for the techniques described herein may be found in Steihaug T., “A conjugate gradient method and trust regions in large scale optimization”, SIAM Journal of Numerical Analysis, 20(3) pp. 626-637, 1983.

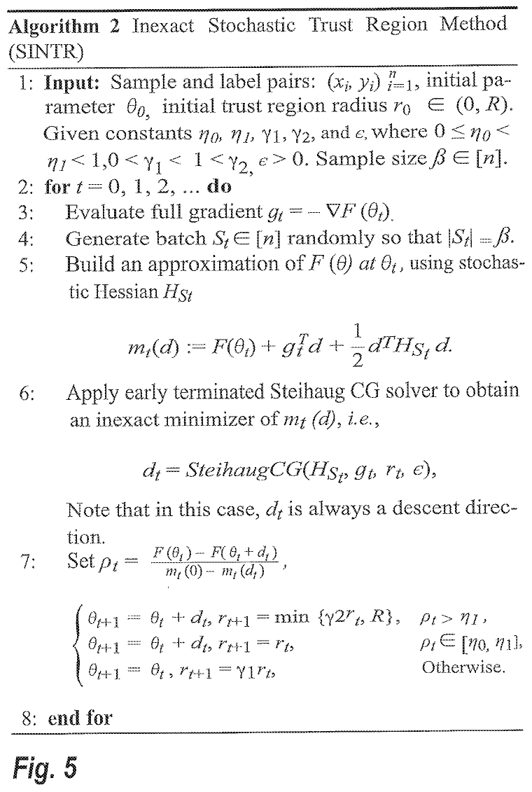

Starting at step 405, a loss function a loss function corresponding to the deep neural network is defined. In some embodiments, the loss function can be specified directly in the source code executing the method; while, in other embodiments, the loss function may be supplied as an input value to the source code. At step 410, input values are received by the computing system executing the method 400. These input values include, without limitation, a training set of labeled pairs (xᵢ, yᵢ)ᵢ₌₁ⁿ, an initial iterate of parameter values Θ₀, and an initial trust region radius r₀∈(0,R). Additionally, constants η₀, η₁, γ₁, η₂, and ϵ are supplied as inputs, where 0<η₀<η₁<1, 0<γ₁<1<γ₂, ϵ>0 (see FIG. 5). Finally, the sample size is defined as β∈[1, 2, . . . , n]. At step 415, the inputs are initialized, as necessary, to predetermined initial values.

An optimization method is performed at steps 420-440 to iteratively minimize the loss function over a plurality of iterations. Starting at step 420, the gradient for the loss function at the current parameter values is calculated (i.e., gₜ=−∇F(Θ_{T})). Next, at step 425, a batch of training samples is selected. As with the method 200 discussed above with respect to FIG. 2, random sampling may be used to generate the batch at step 420. That is, a batch S_{T}∈[n] is generated randomly so that |S_{T}|=β.

Then, at step 430, a trust region subproblem is constructed that approximates the loss function using the gradient and a stochastic Hessian matrix of the loss function with respect to the batch of samples. That is, an approximation of F(Θ) at Θ_{T} is built using a stochastic Hessian H_{S}_{ₜ}. For the purposes of this discussion, let this approximation be noted as mₜ(d). In some embodiments, the trust region radius corresponds as a spherical area in which the trust region subproblem lies. Additionally, in some embodiments, the trust region subproblem may be a bounded quadratic minimization problem

Next step 435, a descent direction is determined by applying a SteihaugCG solver to the trust region subproblem given the trust region radius. More specifically, an earlier terminated SteihaugCG solver is applied obtain an inexact minimizer of mₜ(d), denoted herein as dₜ. The current parameter values and the trust region radius are conditionally updated at step 440 based on a comparison of (i) a true reduction value provided by the loss function given the current parameter values, and (ii) a predicted reduction value provided by the descent direction. Continuing with the terminology used above, the value of Θ_{T+1}, is updated based on the mₜ and dₜ, and the following value is calculated:

$${ρ}_{t} = \frac{F ( {Θ}_{T} ) - F ( {Θ}_{T} + {d}_{t} )}{{m}_{t} ( 0 ) - {m}_{t} ( d )}$$

Then, based on a comparison of ρₜ with the constants η₀ and η₁, the values of Θₜ₊₁ and the trust region radius rₜ₊₁ are set for the next iteration.

After updating the values, the method 400 then repeats again starting at step 420 until convergence or a desired number of steps is performed. The methodology for setting the values of Θₜ₊₁ and rₜ₊₁ is set forth in the pseudocode presented in FIG. 5. Following the optimization method, the current parameter values are stored at step 445 in relationship to the deep neural network.

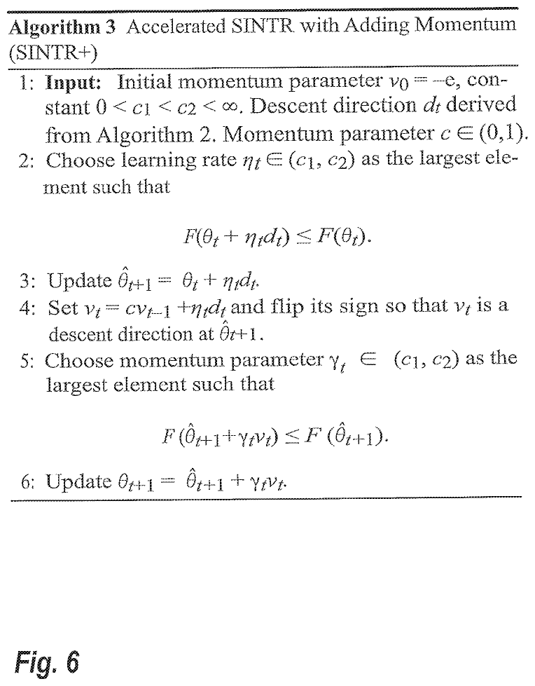

In some embodiments, a momentum parameter may be added to SINTR to improve the escaping efficiency from saddle points. One example algorithm, referred to herein as SINTR+, is shown in FIG. 6. Note that in SINTR, although we are able to escape the saddle point, it usually takes many iterations to accomplish this. SINTR+ reduces the iterates need for escaping. This is quite beneficial because each iteration incurs a high computational cost and therefore reducing the number of iterations result in more efficient algorithm. The difference between SINTR+ and SINNC is that the SINTR+ moves are made as far as possible from the starting point. These heuristics may be achieved in two steps. First, as long as we derived the descent direction dₜ from SINNC, instead of using it directly with step-size equal to 1, an extra line search is followed. Around the saddle, the objective value always changes very tiny; thus, the sufficient reduction requirement for convergence guarantee may be removed with the aim of selecting the largest step-size along dₜ. Second, achieving the furthest move along the descent direction d_{b}, extra momentum may be added for further performance improvement. The momentum is accumulated from the previous direction. This actually helps avoid the saddle point because, near the saddle, the angles between any two adjacent iterates are very tiny in some iterations.

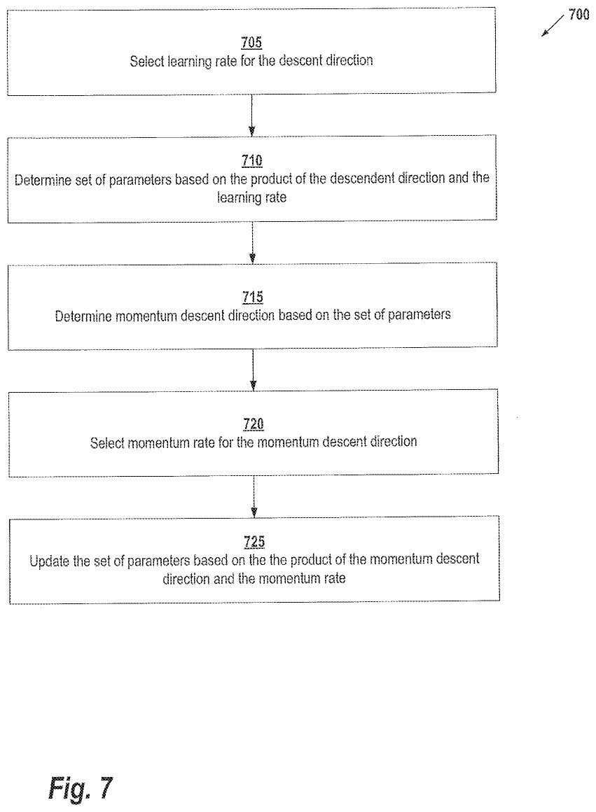

FIG. 7 provides an overview of how momentum, determined using SINTR+, may be used to update parameters following execution of the rest of the SINTR method 400 (see FIG. 4). Starting at step 705 a learning rate is selected for the decent direction. Next, at step 710 a first set of parameters is determined based on the product of the descent direction and the learning rate. At step 715, a momentum descent direction is determined at the first set of parameters and, at step 720, a momentum rate for the momentum descent direction is selected. Then, at step 725, the current parameter values are updated based on the first set of parameters and the product of the momentum descent direction and the momentum rate. The aforementioned learning rate may be determined, for example, using a backtracking line search based on the loss function, the current parameter values, and the descent direction. Similarly, the momentum rate may be determined using a backtracking line search based on the loss function, the first set of parameters, and the momentum descent direction. As is generally understood in the art, in minimization procedures, a backtracking line search is a line search method to determine the maximum amount to move along a given search direction by iteratively shrinking the step size (i.e., “backtracking”) until a decrease of the objective function is observed that adequately corresponds to the decrease that is expected, based on the local gradient of the objective function.

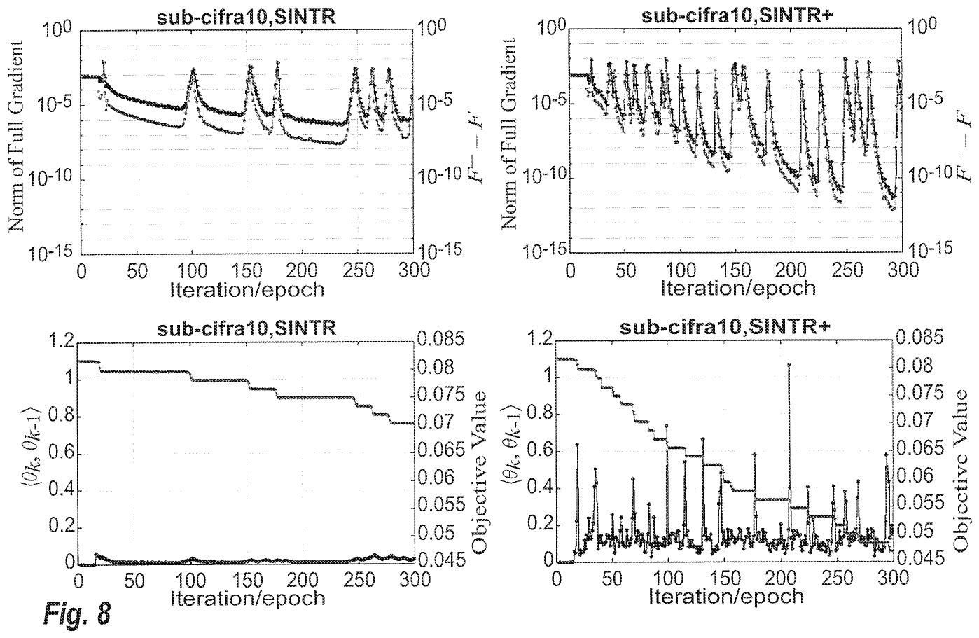

FIG. 8 shows the evolution of angles between two adjacent iterative points (bottom row) and the corresponding optimization performance of SINTR and SINTR+. These results suggest that further movement along the momentum direction vₜ may be beneficial. As long as we can verify that vₜ is a descent direction, the largest step-size for the momentum direction may be determined. The update for current iterate is then defined as the sum of descent direction dₜ movement and extra momentum descent direction vₜ. As shown in FIG. 8, the reduction in the objective function by using SINTR+, is achieved when there is substantial increase in the angle between consecutive iterations. In contrast, SINTR cannot sufficiently decrease the objective since the angles of consecutive iterations are always small and do not fluctuate enough.

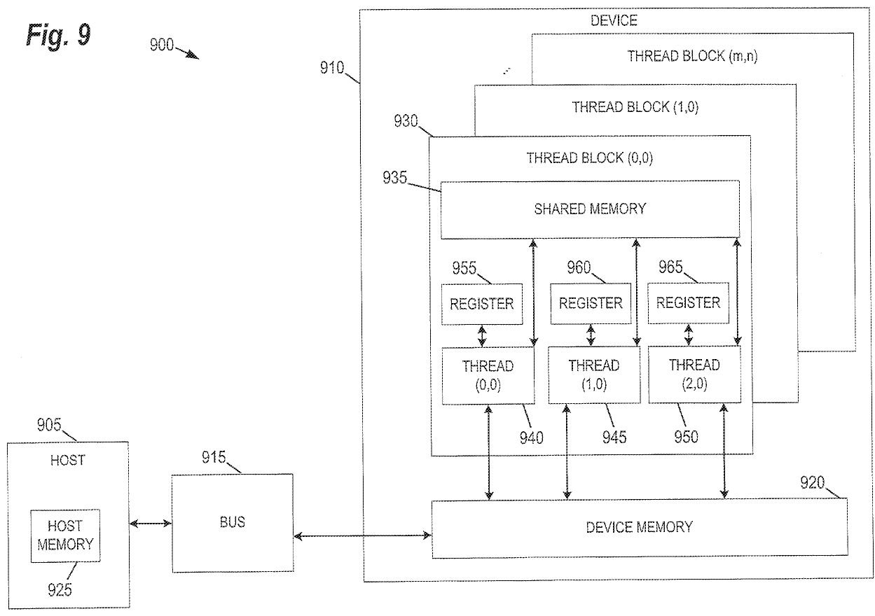

FIG. 9 provides an example of a parallel processing memory architecture 900 that may be utilized by to perform computations related to execution of the algorithms discussed herein, according to some embodiments of the present invention. This architecture 900 may be used in embodiments of the present invention where NVIDIA™ CUDA (or a similar parallel computing platform) is used. The architecture includes a host computing unit (“host”) 905 and a GPU device (“device”) 910 connected via a bus 915 (e.g., a PCIe bus). The host 905 includes the central processing unit, or “CPU” (not shown in FIG. 9) and host memory 925 accessible to the CPU. The device 910 includes the graphics processing unit (GPU) and its associated memory 920, referred to herein as device memory. The device memory 920 may include various types of memory, each optimized for different memory usages. For example, in some embodiments, the device memory includes global memory, constant memory, and texture memory.

Parallel portions of a deep learning application may be executed on the architecture 900 as “device kernels” or simply “kernels.” A kernel comprises parameterized code configured to perform a particular function. The parallel computing platform is configured to execute these kernels in an optimal manner across the architecture 900 based on parameters, settings, and other selections provided by the user. Additionally, in some embodiments, the parallel computing platform may include additional functionality to allow for automatic processing of kernels in an optimal manner with minimal input provided by the user.

The processing required for each kernel is performed by grid of thread blocks (described in greater detail below). Using concurrent kernel execution, streams, and synchronization with lightweight events, the architecture 900 of FIG. 9 (or similar architectures) may be used to parallelize training of a deep neural network. For example, in some embodiments, the training dataset is partitioned such that multiple kernels execute the SINNC or SINTR algorithm simultaneously on subsets of the training data. In other embodiments, the SteihaugCG solver, or other components of the algorithms, may be implemented such that various operations performed with solving the system are done in parallel.

The device 910 includes one or more thread blocks 930 which represent the computation unit of the device 910. The term thread block refers to a group of threads that can cooperate via shared memory and synchronize their execution to coordinate memory accesses. For example, in FIG. 9, threads 940, 945 and 950 operate in thread block 930 and access shared memory 935. Depending on the parallel computing platform used, thread blocks may be organized in a grid structure. A computation or series of computations may then be mapped onto this grid. For example, in embodiments utilizing CUDA, computations may be mapped on one-, two-, or three-dimensional grids. Each grid contains multiple thread blocks, and each thread block contains multiple threads. For example, in FIG. 9, the thread blocks 930 are organized in a two dimensional grid structure with m+1 rows and n+1 columns. Generally, threads in different thread blocks of the same grid cannot communicate or synchronize with each other. However, thread blocks in the same grid can run on the same multiprocessor within the GPU at the same time. The number of threads in each thread block may be limited by hardware or software constraints. In some embodiments, processing of subsets of the training data or operations performed by the algorithms discussed herein may be partitioned over thread blocks automatically by the parallel computing platform software. However, in other embodiments, the individual thread blocks can be selected and configured to optimize training of the deep neural network. For example, in one embodiment, each thread block is assigned a subset of training data with overlapping values.

Continuing with reference to FIG. 9, registers 955, 960, and 965 represent the fast memory available to thread block 930. Each register is only accessible by a single thread. Thus, for example, register 955 may only be accessed by thread 940. Conversely, shared memory is allocated per thread block, so all threads in the block have access to the same shared memory. Thus, shared memory 935 is designed to be accessed, in parallel, by each thread 940, 945, and 950 in thread block 930. Threads can access data in shared memory 935 loaded from device memory 920 by other threads within the same thread block (e.g., thread block 930). The device memory 920 is accessed by all blocks of the grid and may be implemented using, for example, Dynamic Random-Access Memory (DRAM).

Each thread can have one or more levels of memory access. For example, in the architecture 900 of FIG. 9, each thread may have three levels of memory access. First, each thread 940, 945, 950, can read and write to its corresponding registers 955, 960, and 965. Registers provide the fastest memory access to threads because there are no synchronization issues and the register is generally located close to a multiprocessor executing the thread. Second, each thread 940, 945, 950 in thread block 930, may read and write data to the shared memory 935 corresponding to that block 930. Generally, the time required for a thread to access shared memory exceeds that of register access due to the need to synchronize access among all the threads in the thread block. However, like the registers in the thread block, the shared memory is typically located close to the multiprocessor executing the threads. The third level of memory access allows all threads on the device 910 to read and/or write to the device memory. Device memory requires the longest time to access because access must be synchronized across the thread blocks operating on the device. Thus, in some embodiments, the processing of each seed point is coded such that it primarily utilizes registers and shared memory and only utilizes device memory as necessary to move data in and out of a thread block.

The embodiments of the present disclosure may be implemented with any combination of hardware and software. For example, aside from parallel processing architecture presented in FIG. 9, standard computing platforms (e.g., servers, desktop computer, etc.) may be specially configured to perform the techniques discussed herein. In addition, the embodiments of the present disclosure may be included in an article of manufacture (e.g., one or more computer program products) having, for example, computer-readable, non-transitory media. The media may have embodied therein computer readable program code for providing and facilitating the mechanisms of the embodiments of the present disclosure. The article of manufacture can be included as part of a computer system or sold separately.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

An executable application, as used herein, comprises code or machine readable instructions for conditioning the processor to implement predetermined functions, such as those of an operating system, a context data acquisition system or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters.

A graphical user interface (GUI), as used herein, comprises one or more display images, generated by a display processor and enabling user interaction with a processor or other device and associated data acquisition and processing functions. The GUI also includes an executable procedure or executable application. The executable procedure or executable application conditions the display processor to generate signals representing the GUI display images. These signals are supplied to a display device which displays the image for viewing by the user. The processor, under control of an executable procedure or executable application, manipulates the GUI display images in response to signals received from the input devices. In this way, the user may interact with the display image using the input devices, enabling user interaction with the processor or other device.

The functions and process steps herein may be performed automatically or wholly or partially in response to user command. An activity (including a step) performed automatically is performed in response to one or more executable instructions or device operation without user direct initiation of the activity.

The system and processes of the figures are not exclusive. Other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. As described herein, the various systems, subsystems, agents, managers and processes can be implemented using hardware components, software components, and/or combinations thereof. No claim element herein is to be construed under the provisions of 35 U.S.C. 112(t) unless the element is expressly recited using the phrase “means for.”

1. A computer-implemented method for training a deep neural network, the method comprising:
defining a loss function corresponding to the deep neural network;
receiving a training dataset comprising a plurality of training samples;
setting current parameter values to initial parameter values;
perform an optimization method which iteratively minimizes the loss function over a plurality of iterations, wherein each iteration comprises:
calculating a steepest direction of the loss function by determining the gradient of the loss function at the current parameter values,
selecting a batch of samples included in the plurality of training samples,
apply a matrix-free CG solver to obtain an inexact solution to a linear system defined by the steepest direction of the loss function and a stochastic Hessian matrix with respect to the batch of samples,
determining a descent direction based on the inexact solution to the linear system and the steepest direction of the loss function, and
updating the current parameter values based on the descent direction; and
following the optimization method, storing the current parameter values in relationship to the deep neural network.

2. The method of claim 1, wherein the current parameter values are updated based on the descent direction and a learning rate calculated using the steepest direction of the loss function and the descent direction.

3. The method of claim 2, wherein the learning rate is calculated using an Amijo line search method.

4. The method of claim 2, wherein the learning rate is calculated using a Goldstein line-search method.

5. The method of claim 1, wherein the batch of samples comprises a random sampling of the plurality of training samples.

6. The method of claim 5, wherein the random sampling the plurality of training samples is resampled during each of the plurality of iterations.

7. The method of claim 1, wherein the optimization method is performed using a parallel computing platform and computing operations associated with the optimization method are performed in parallel across a plurality of processors included in the parallel computing platform.

8. A computer-implemented method for training a deep neural network, the method comprising:
defining a loss function corresponding to the deep neural network;
receiving a training dataset comprising a plurality of training samples;
setting current parameter values to initial parameter values;
using a computing platform to perform an optimization method which iteratively minimizes the loss function over a plurality of iterations, wherein each iteration comprises:
calculating a gradient for the loss function at the current parameter values;
selecting a batch of samples included in the plurality of training samples,
constructing a trust region subproblem that approximates the loss function using the gradient and a stochastic Hessian matrix of the loss function with respect to the batch of samples,
determining a descent direction by applying a SteihaugCG solver to the trust region subproblem given a trust region radius, and
conditionally updating the current parameter values and the trust region radius based on a comparison of (i) a true reduction value provided by the loss function given the current parameter values, and (ii) a predicted reduction value provided by the descent direction; and
following the optimization method, storing the current parameter values in relationship to the deep neural network.

9. The method of claim 8, wherein the batch of samples comprising a random sampling of the plurality of training samples.

10. The method of claim 9, wherein the random sampling the plurality of training samples is resampled during each of the plurality of iterations.

11. The method of claim 8, wherein the trust region radius corresponds as a spherical area in which the trust region subproblem lies.

12. The method of claim 8, wherein the trust region subproblem is a bounded quadratic minimization problem.

13. The method of claim 8, wherein the current parameter values are updated by:
selecting a learning rate for the descent direction;
determining a first set of parameters based on the product of the descent direction and the learning rate;
determining a momentum descent direction at the first set of parameters;
selecting a momentum rate for the momentum descent direction; and
updating the current parameter values based on the first set of parameters and the product of the momentum descent direction and the momentum rate.

14. The method of claim 13, wherein the learning rate is determined using a backtracking line search based on the loss function, the current parameter values, and the descent direction.

15. The method of claim 13, wherein the momentum rate is determined using a backtracking line search based on the loss function, the first set of parameters, and the momentum descent direction.

16. The method of claim 8, wherein optimization method is performed using a parallel computing platform and computing operations associated with the optimization method are performed in parallel across a plurality of processors included in the parallel computing platform.
